(19) United States
(12) Patent Application Publication
(10) Pub. No.: US 2017/0202158 A1
(43) Pub. Date: Jul. 20, 2017

(54) ELECTRICALLY HEATED PLANT GROWTH CONTAINER

(71) Applicant: Eric KOCHMAN, Vernon Hills, IL (US)

(72) Inventor: Eric KOCHMAN, Vernon Hills, IL (US)

(21) Appl. No.: 15/387,736

(22) Filed: Dec. 22, 2016

Related U.S. Application Data
(60) Provisional application No. 62/280,833, filed on Jan. 20, 2016.

(51) Int. Cl. A01G 9/26; B65D 43/02; H05B 3/34; A01G 9/24; A01G 7/04; A01G 13/06; B65D 25/20; A01G 9/02

(52) U.S. Cl. CPC A01G 9/26; B65D 25/20; B65D 43/02; A01G 9/02; A01G 9/246; A01G 7/04; A01G 13/06; H05B 3/34

(57) ABSTRACT

The plain growth container is heated by the temperature controlled flexible electrical heating blanket or heating element panel which covers the inside or outside surface of the walls or bottom of the container. The proposed construction allows to maintain the desired warmth of the roots at all stages of the plant development, to promote efficient convective air flow in the plant growing medium, to use DC or AC electric power with optional electromagnetic field cancellation and to use optional antimicrobial additives inside the heating blanket and insulation top cover to prevent mold and disease propagation.

### CROSS-REFERENCE TO RELATED APPLICATIONS

The present application claims priority to U.S. provisional application No. 62/280,833 filed on Jan. 20, 2016, which is incorporated limit by reference.

### FIELD OF THE INVENTION

The present invention relates to the technical field of flexible electrical heaters and plant growth containers. More particularly, the present invention is in the technical field of the thermostatically controlled flexible heaters which maintain the desired temperature of the plant growing medium, provide optional antimicrobial treatment and generate convective air flow inside the plant growth container.

### BACKGROUND OF THE INVENTION

In today's world, the key problems related to propagating and growing plants are maintaining a controlled temperature of the plant growing medium and providing sufficient aeration of the roots throughout the whole plant growth period. An attempt to resolve these problems by heating plant growth containers was described in the U.S. Pat. No. 7,634,872, Prescott, Dec. 22, 2009. One of the drawbacks of this solution is the use of a dual wall container, where the space between the walls is filled with the warm water. The proposed heating system does not allow growing medium to be drained of the excess water in the plant growth container, which is vital for non-aquatic plants. In addition, the water that fills the space between the dual walls and the bottom of the proposed container prevents any aeration of the growing medium. The proposed construction also does not allow air pruning, which is responsible for promoting healthy development of the roots of non-aquatic plants grown in containers. Due to these drawbacks, the invention is only applicable to aquatic plants. Another attempt to heat the roots inside a plant propagation container was described in the U.S. patent application Ser. No. 13/851,193 (publication Number US 20140290131 A1). Inskeep, Oct. 2, 2014. One of the major drawbacks of this solution is the use of a small heating element that is only placed inside the growing medium under the small roots and the plant cuttings. This small heating element provides heat to a limited volume of soil, which could cause overheating of localized spots in the growing medium and significant temperature variance in the root zone of the plant growth container. The author confirms this drawback by stating that the small heating element is designed to be buried in close proximity to the young roots of the plant or cutting because the growing medium inside the container has low thermal conductivity. The localized placement of the small heating element and the temperature variance of the plant growth container make the proposed solution inefficient for well-developed roots that tend to spread throughout the entire bulk of the growing medium of the plant growth container. Therefore, this solution is only applicable to the early stages of root propagation because it cannot achieve uniform heat distribution throughout the entire hulk of the growing medium. Moreover, this patent application does not offer the following solutions: convective aeration of the growing medium, efficient air pruning of the roots, electrical grounding of the growing medium, energy saving heat insulation, or a top cover with antimicrobial function. Another drawback of this patent application is the use of only direct current (DC) power supply source, while alternating current (AC) could also provide a safe, efficient and less expensive energy source solution.

The present invention seeks to alleviate the drawbacks of the prior art and describes the novel method of providing optimized root zone temperature control and aeration in the plant growth containers. The present invention describes fabrication of the heated plant growth container comprising the removable electrical heating blanket and temperature control means for warming the plant growing medium of non-aquatic plants. The electric heating blanket envelops the plant growing medium from the inside or outside of the walls and/or the bottom of the plant growth container, providing optimum heat distribution in the entire bulk of the growing medium. Alternatively, the electric heating blanket is permanently embedded or laminated inside the walls of the plant growth container. The optional electrical grounding, insulation, energy saving top cover and antimicrobial functions of both, the heating blanket and the top cover are also described in detail in the present invention.

### SUMMARY OF THE INVENTION

The first objective of the invention is to provide an effective method of heating the entire plant growing medium to optimize the root zone temperature of non-aquatic plants. In order to achieve the first objective, a flexible electric heating blanket envelops the surface of the inside or outside walls and/or bottom of the plant growth container. Alternatively, the electric heating blanket is permanently embedded into the walls of the plant growth container. The electric heating blanket is then electrically energized either by DC or AC. A preferable option is to energize the electric heating blanket with heating cables that have an electromagnetic field (EMF) cancellation function.

The second objective of the invention is to provide an efficient root zone temperature control inside the growing medium of the plant growth container. In order to achieve the second objective, the temperature control means is placed in close proximity to the heating blanket and/or the plant growing medium. At least one temperature sensor or thermostat is placed inside the growing medium to control and optimize the root zone temperature. It is possible to connect multiple electrically heated plant growth containers in parallel to one electrical power source and one temperature control means, providing that the temperature sensor is inserted in only one of the multiple plant growth containers. Said one temperature sensor and one temperature control means can measure the growing medium temperature of one of said multiple growth containers and simultaneously electrically energize or terminate the electrical power of all said multiple containers.

An optional additional thermostat is placed inside the electric heating blanket to maintain the desired surface temperature of the heating blanket and prevent its overheating. The temperature control means may also contain an optional thermostat to measure the outside ambient temperature. By measuring the outside ambient temperature, the thermostat could signal the electric heating blanket to turn on in a cold environment, preventing the undesired cooling or freezing of the root zone inside the plant growth container.

The third objective of the invention is to provide an enhanced aeration of the growing medium and air pruning of the roots inside the plant growth container. In order to achieve this objective, an optional enhanced amount of perforations, holes in the container, air permeable insulation or breathable electric heating blanket are used. The heat generated by the electrical heating blanket induces the convective force which draws the outside ambient air inside the growing medium. In the case that the heated plant growth container has fabric or air permeable perforated walls, the electric heating blanket of the proposed invention is made from the air permeable heating element holding means, to allow for aeration of the growing medium and air pruning of the roots inside of the plant growth container.

The fourth objective of the invention is to provide maximum energy efficiency and energy saving to the heated plant growth container. In order to achieve this objective, the optional insulation medium and optional air permeable top cover are added to the heated plant growth container. The insulation medium is placed either from the inside or outside walls and/or bottom of the plant growth container to reflect and/or retain heat generated by the beating blanket. The air permeable top cover is placed on the top of the plant growth container to allow for air penetration and to reduce heat loss from the top surface of the growing medium of the plant growth container.

The fifth objective of the invention is to provide optional electrical grounding of the growing medium. In order to achieve this objective an electrical grounding medium is connected to electrical ground wiring of the power source and then introduced directly to the growing medium.

The sixth objective of the invention is to provide optional one-way directed static magnetic field in the growing medium to enhance growth and health of the roots in the plant growth container. In order to achieve this objective, the electrical heating blanket can be constructed in such a way that a direct electrical current travels either upward or downward in the electrical blanket.

The seventh objective of the invention is to provide optional antimicrobial function to the electric heating blanket and air permeable top cover. In order to achieve tins objective, said heating blanket and the top cover are coated, mixed or impregnated with antimicrobial medium, preventing the spread of diseases and mold inside the plant growing medium.

The present invention comprises a plant growth container that has a flexible temperature controlled electric heating blanket designed to warm the entire bulk of the plant growing medium. The heating blanket is attached to the outside or inside walls or bottom of the plant growth container. The outside walls of the plant growth container may be covered with an optional insulation layer to retain heat in the growing medium. The optional insulation layer can also be placed within the inner walls of the plant growth container. Another embodiment of the invention describes an electric heating element panel, which is permanently molded inside the walls of the plant growth container. In the event that a breathable fabric growth container is utilized, the electrical heating panel can be permanently attached to the inner fabric walls by stitching, weaving or laminating. The flexible heating panel is electrically energized either by Direct Current (DC) or Alternating Current (AC). It is preferable to energize the heating blanket with alternating current using dual cable heating elements that provide Electro-Magnetic Field (EMF) cancellation. The optional electric grounding to the Earth of the plant growing medium can be applied. The heating blanket may also be energized by direct current applied to the heating elements which provide constant upward or downward direction of the current flow to promote the plant growth by the static magnetic field. The heated plant growth container comprises optional air and water permeable (also called herein as “breathable”) insulation cover on the top of the container to retain heat inside the growing medium. Both flexible heating blanket and breathable insulation top cover may comprise optional antimicrobial medium to prevent disease and mold propagation.

### BRIEF DESCRIPTION OF THE DRAWINGS

FIG. 1 is a side view of the plant growth container with the flexible heating blanket, insulation top cover and a temperature control means of the present invention.

FIG. 2 is an isometric view of the flexible heating blanket of the present Invention.

FIG. 3 is an isometric view of the insulation top cover of the present Invention.

FIG. 4 is a cross section view of the plant growth container with the flexible heating element panel molded inside of the walls of the plant growth container of the present invention.

FIG. 5 is a top view of the plant growth container with the flexible heating element panel attached to the inner wall of the plant growth container of the present invention.

FIG. 6 is a top view of the flexible heating element panel of the present invention.

FIG. 7 is a top view of the flexible heating panel of the present invention.

FIG. 8 is a side view of the plant growth container with flexible heating panel and temperature control means of the present invention.

FIG. 9 is an isometric view with a cross section of the plant growth container having dual heating element cable of the present invention.

FIG. 10 is an isometric view of the shielded dual heating element cable of the present invention.

FIG. 11 is an isometric view of multiple plant growth containers, connected to one temperature control means of the present invention.

### DETAILED DESCRIPTION OF THE INVENTION

The invention consists of the plant growth container with an electrical heating blanket attached to the walls and/or bottom of the said container and temperature control means to provide warming, aeration, heat control and temperature stabilization of the entire bulk of the growing medium.

The term “plant growth container” or “nursery pot” described in this invention shall mean any container, box or bag suitable for growing plants outdoors or indoors, including warehouses and greenhouses.

The terms “electric heating medium”, “electric heating blanket” “electric heating panel”, or “resistance heating medium” described in this invention shall mean any electrical heat radiating device containing an electric heating element, heating element holding means and cold lead wires. The electric heating element can comprise heating cables, heating wires or fibers, conductive ink, metal heating strips or flexible panels.

The term “heating element holding means” described in this invention shall mean any material for holding the heating element in the desired pattern and secured position inside or outside of the walls and/or bottom of the plant growth container. Said heating element holding means can comprise textile fabric, foam, felt, adhesive, threads, polymer film, fastener, or adhesive tape.

The term “insulation medium” described in this invention shall mean any material which insulates the electric heating medium from the ambient environment and promotes retention and reflection of the heat towards the growing medium of the plant growth container. The insulation medium can be made from a flexible or rigid material, contain a heat reflective layer, such as aluminum foil or metallized polymer film, or be air and/or water permeable. An optional fiber felt-like breathable insulation medium can be used in this invention, which can provide either heat insulation or cooling functions. The insulation medium provides heat insulation function when the electric heating blanket is electrically energized. The insulation medium can provide cooling function when moisture evaporates from the wet felt-like insulation medium and when the electric heating blanket is not energized.

The term “plant growing medium” or “growing medium” described in this invention shall mean any substance through which roots grow and extract water and/or nutrients in the plant growth container.

The term “convective air flow medium” described in this invention shall mean air permeable materials, comprising holes, perforations on the plant growth containers, insulation means or air permeable materials of the electric heating blanket. Said air permeable materials of the electric heating blanket may comprise perforated holes or cutouts, a breathable insulation medium, such as fabric felt or heating element holding means in a form of air permeable fabric, fiberglass, textile or plastic mesh, tape or perforated plastic film.

The term “air pruning” described in this invention shall mean a process of exposing the tips of the roots to relatively dry air, causing them to dehydrate and become air-pruned, thus this process promotes the healthy growth of the plant and dense root hairs inside of the plant growing medium.

The term “heating element cable” described in this invention shall mean any insulated electrical conductor or combination thereof which generates electric resistance heating when DC or AC electric power is applied through said conductor. Said electrical conductor can comprise metal wires or electrically conductive textile fibers.

The terms “envelops the outside surface of said plant growing medium” or “enveloping by the electrical heating blanket the outside surface of plant growing medium”, described in this invention shall mean the placement of the electrical heating blanket either from the inside or outside wall surface and or bottom of the plant growth container in close proximity to the growing medium to assure maximum heat exchange between said heating blanket and said growing medium.

The term “electrical power source” described in this invention shall mean any electric direct current. (DC) or alternating current (AC) power source providing voltage from 6 Volts to 480 Volts.

The term “temperature control means” described in this invention shall mean any electronic or mechanical device or temperature sensitive film, which can perform at least one of the following functions: sensing, indicating, measuring, stabilizing, monitoring or controlling the temperature of the growing medium inside the plant growth container, the ambient temperature and/or the heating blanket surface temperature. An example of said electronic device is an electronic thermostat comprising flexible temperature sensor, monitor and relay. Said electronic thermostat can control the temperature of one or multiple plant growth containers connected in parallel to one electrical power source. The temperature control means can measure the temperature of the growing medium of only one plant growth container and turn on or off said electric power source, thus simultaneously controlling the warming function of said multiple plant growth containers. An example of said mechanical device of the temperature control means is a bi-metal thermostat. An example of said temperature sensitive film of the temperature control means is a sheet of liquid crystal, which can change its color as temperature varies, thus indicating when the electrical blanket of the plant growth container is electrically energized.

The term “insulation top cover” described in this invention shall mean any fabric or polymer material which covers the top surface of the growing medium of the plant growth container. The insulation top cover can comprise at least one of the following functions: air permeability, water permeability, heat insulation, and antimicrobial properties.

The term “antimicrobial medium” described in this invention shall mean any chemical materials, particles or metal containing fibers that comprise antimicrobial properties. Preferably, said metal containing fibers comprise silver or copper.

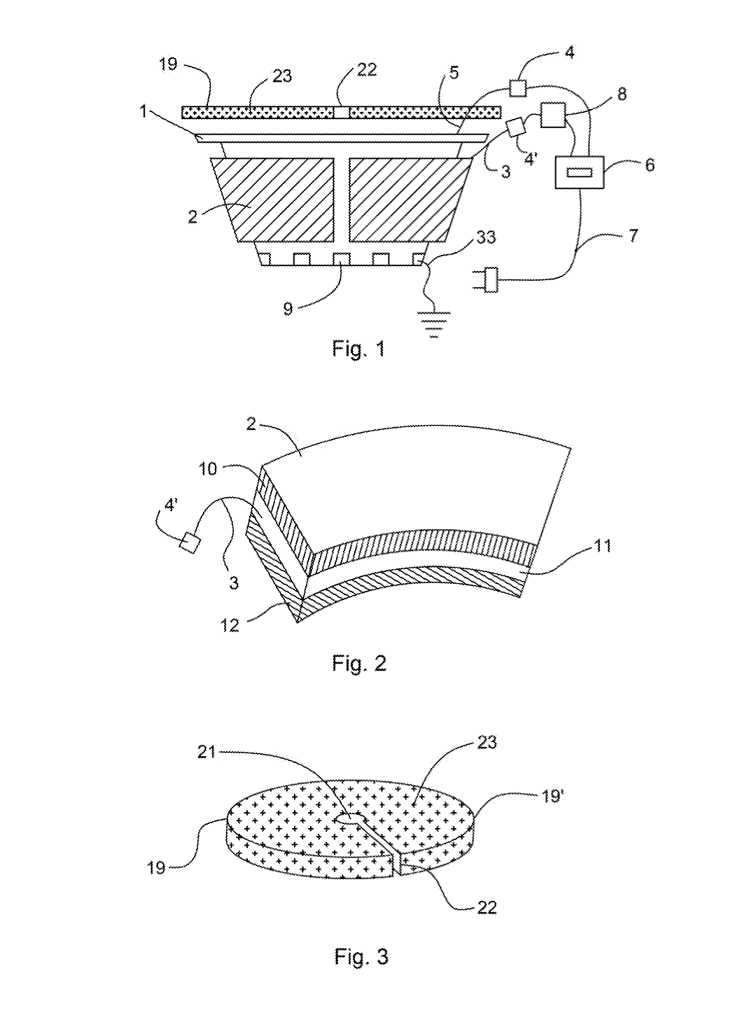

Referring now to the invention in more detail, FIG. 1 illustrates a plastic plant growth container 1 enveloped with the electrical heating blanket 2 outside of the growth container. The heating blanket 2 is connected through the lead wires 3 and quick connectors 4′ to the optional electric transformer 8, which acts as an electric low voltage power supply source. The transformer 8 is connected to the temperature control means 6, which has the temperature sensor 5 that is inserted into the plant growing medium of said container 1. The sensor has the optional quick connector 4 for easy replacement. The temperature control means 6 is connected to a power supply source by cord 7 to maintain the required temperature of the plant growing medium.

In more detail, still referring to FIG. 1, the holes 9 of the plastic growth container 1 are examples of convective air flow medium. These holes permeate the outside ambient air to be drawn into container 1 by a convective force, which is generated by the warm heating blanket 2 and spreads throughout the entire bulk of the plant growing medium. Therefore, it is preferable that the container 1 has an optional increased amount of holes or perforations around the bottom or the entire perimeter of the wall surface of the plant growth container. In the case that an air permeable fabric plant growth container is used, the heating blanket itself comprises convective air flow medium in the form of air permeable heating element holding means. The breathable heating element holding means allows the ambient air to penetrate into the plant growing medium through the entire surface of the electric heating blanket. The convective air flow and circulation of the air inside of the growing medium are very beneficial for the plant root systems, which require oxygen for aerobic respiration, release of energy and nutrient uptake. In addition, the enhanced warming and drying of the outside surface of the growing medium causes beneficial air pruning of the roots, which promotes healthy root development inside of the plant growing medium.

In more detail, still referring to FIG. 1, the plant growth container 1 has optional container insulation top cover 19 to retain the desired heat and humidity of the plant growing medium. The top cover 19 is made of the optional air permeable materials such as non-woven felts or fabrics. Said top cover may contain antimicrobial medium 23.

In more detail, still referring to FIG. 1, the plant growth container 1 shows an optional electrical grounding wire 33 connected directly to Earth and to the plant growing medium inside container 1.

Referring now to the invention in more detail, the flexible heating blanket 2 is described separately in FIG. 2, which shows the outer insulation layer 10, the heating element panel 11 and heating element holding means 12 for holding the heating blanket 2 in close proximity to the walls of the container 1. Lead wires 3 and quick connectors 4′ are attached to the flexible heating element panel 11.

Referring now to the invention in more detail, an optional insulation top cover 19 is described separately in FIG. 3, illustrating an air permeable fabric 19′ and cuts 21 and 22 for the stem of the plant. The insulation top cover 19 contains optional antimicrobial medium 23.

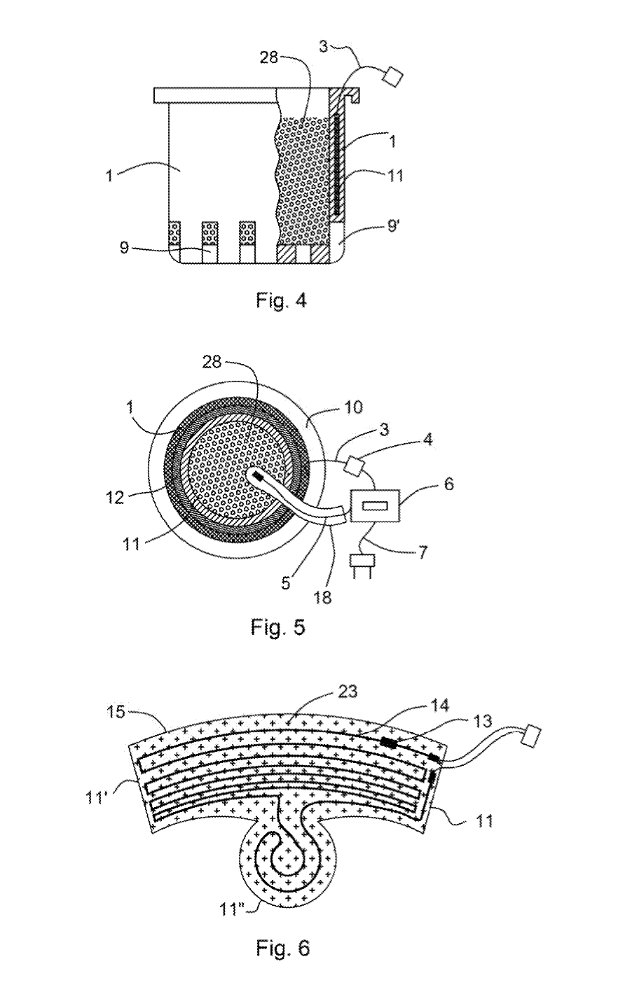

The alternative embodiment of the current invention is described in FIG. 4, where an electrical heating element panel 11 is embedded or molded inside the plastic walls and, optionally, inside the bottom of the plant growth container 1 during its manufacturing. The heating element panel 11 envelops the entire bulk of the growing medium 28 of the container 1 inside its wall perimeter. The heating element panel 11 is hermetically insulated by the polymer material of the container 1 and is electrically connected by the lead wires 3. The optional increased amount of openings 9 and 9′ in the plant growth container 1 provides convective air flow to the plant growing medium 28 when the heating blanket is electrically energized and generates heat. This preferred molded prefabricated embodiment allows easy cleaning and multiple use of the plant growth container.

The alternative embodiment of the current invention is described in FIG. 5, where the flexible heating element panel 11 is placed inside of the plant growth container 1 as a liner and has direct contact with the plant growing medium 28. The optional air permeable heating element holding means 12 secures the attachment of the heating element panel 11 to the inner walls of the container 1. The lead wires 3 and quick connectors 4 are attached to the flexible heating element panel 11. The optional insulation medium 10 is wrapped around and attached to the outer walls of the container 1. Alternatively, insulation medium 10 can also be placed inside of the plant growth container between the wall of the plant growth container and the heating element panel, reflecting the heat towards the entire bulk of the growing medium 28.

In more detail, still referring to FIG. 5, the temperature control means comprises the temperature sensor 5, which is protected by an optional disposable waterproof insulation or cover 18 and inserted inside the growing medium. The temperature sensor 5 and electronic controller 6 act together as the temperature control means. Said controller 6 is connected to an electrical power source by cord 7 to maintain the required temperature of the plant growing medium.

Referring now to the invention in more detail, the optional construction of the heating element panel 11 is described separately in FIG. 6, showing the heating element cable 14 attached to an air permeable fabric 15, which acts as a heating element holding means. The heating element cable 14 may vary in a pattern layout, providing similar or different electric power density at the bottom and at the top of the heating element panel 11. It is preferable to have gradual change of the desired heating power density throughout the height of the heating element panel 11. Depending on the shape of the plant growth container and its application, it is preferable that there is a higher power density at either the top or at the bottom side of the plant growth container.

In more details, still referring to FIG. 6, the heating element holding means 15, which also acts as the convective air flow medium, contains optional antimicrobial medium 23. The preferred embodiment of the current invention displays two connected parts of the heating element panel 11: the upper heating element panel 11′, which is designed to be wrapped around the inner or outer surface of the walls of plant growth container, and lower heating element panel 11″, which designed to heat the bottom of the container. The simultaneous enveloping of the growing medium by the electric heating blanket assures that the entire bulk of the growing medium is uniformly heated. Such comprehensive enveloping of the growing medium by the electric heating blanket is especially beneficial for large size plant growth containers.

In further detail, still referring to FIG. 6, an optional internal bi-metal thermostat 13 acts as a temperature control means and is attached to the heating element panel 11. Said thermostat 13 is designed to prevent the heating element panel 11 from overheating.

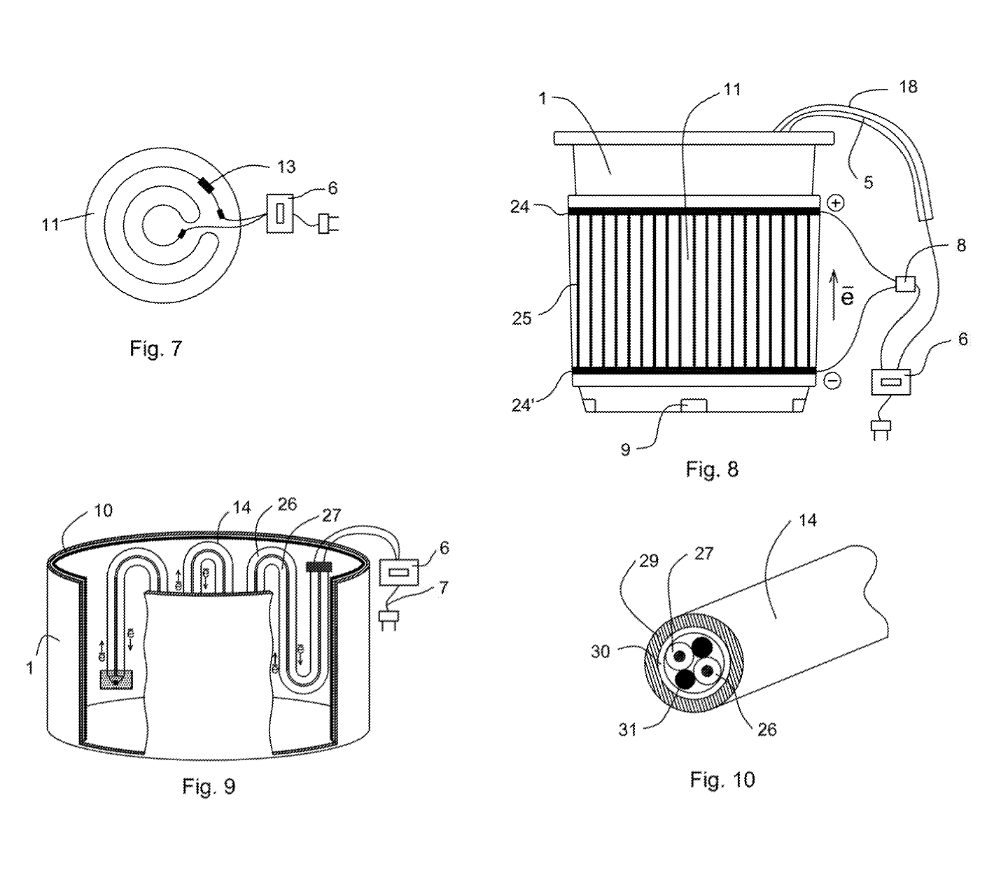

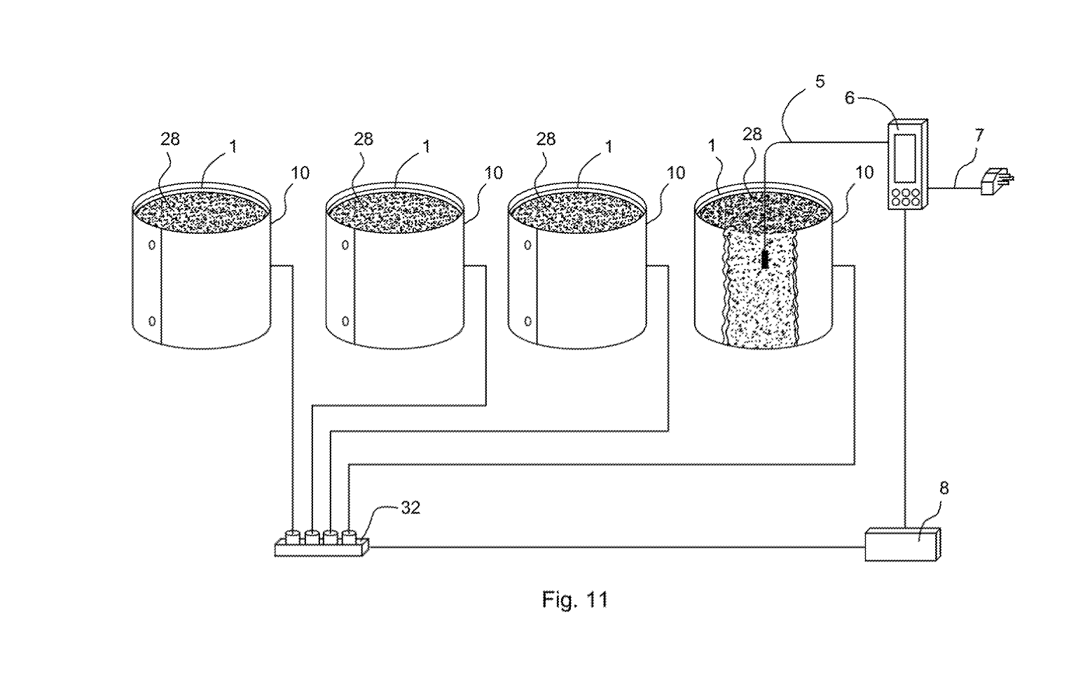

The alternative embodiment of the current invention is described in FIG. 7, where the heating element panel 11 is placed at the bottom of the plant growth container.

Referring now to the invention in more detail, FIG. 8 shows a plant growth container 1, which is wrapped with the alternative construction of heating element panel 11. Said panel 11 has two parallel electrical bus conductors 24 and 24′ that are electrically connected to a Direct Current (DC) power output. One bus conductor 24′ is placed closer to the bottom of the container 1 and another parallel bus conductor 24 is placed closer to the top of the container 1. The heat generating heating medium (for example, conductive ink) 25 is electrically connected to both bus conductors 24 and 24′. The described heating element panel 11 is connected to a DC power source in such a way that the negative pole is connected to a lower bus conductor 24′ and the positive pole is connected to the upper bus conductor 24. The described position of the parallel bus conductors and their electrical connection provides the following functions: the direct electrical current that travels upward induces better root growth by the static magnetic field and the resistive heating medium 25 warms the plant growing medium of the container 1. The temperature inside the plant growth container 1 is controlled by electronic controller 6 and sensor 5 which act together as the temperature control means.

The alternative embodiment of the current invention is described in FIG. 9, showing the optional dual electric heating element cable 14 for use with alternating current (AC). The heating element cables are attached to the insulation medium 10 on the inside walls of the plant growth container 1. Each of the two insulated heating element cables 26 and 27 are connected to the power cord 7 and the temperature control means 6 from one end and then electrically connected together at the other end of said dual heating element cable 14. This preferred dual heating element cable construction provides the electrons to move in the opposite direction in said heating element cables 26 and 27 at any moment while the alternating current (AC) is applied. The described simultaneous opposite electrical current flow minimizes the electromagnetic field (EMF) inside of the plant growth container 1 and prevents possible negative effects of EMF to the plant growth. The single heating element cable construction may be also offered in this invention for heating the growing medium using AC for a variety of plant growth containers.

The alternative embodiment of the current invention is described in FIG. 10, where the dual heating element cable 14 comprises heating cables 26 and 27, which provides simultaneous opposite current flow when AC is applied, the internal grounding wire 31, the grounding metal containing shield 30 and the outer waterproof polymer insulation 29. This preferred embodiment of the dual heating element cable 14 provides maximum EMF cancellation, electrical grounding and radio frequency protection, while supplying safe and efficient heating to the plant growing container of the current invention.

The alternative embodiment of the current invention is described in FIG. 1, where the multiple fabric heated plant growth containers 1, which have the outer breathable insulation medium 10, are electrically connected in parallel to one electrical power source 8 through the splitter connector 32. The temperature control means includes one electronic controller 6 and one sensor 5. Said sensor is inserted inside the growing medium 28 of one of said multiple plant growth containers. The controller 6 is connected to a power source by cord 7 and simultaneously controls the electrical power output in all of said multiple containers.

Furthermore, the use of an electric heated plant growth container in various optional construction embodiments has the following advantages:

it allows to warm the entire bulk of the plant growing medium because the envelopment of the growing medium by the heating blanket, which surrounds the wall and optionally the bottom of the plant growth container, provides maximum and uniform heat exchange surface area;

it allows the use of minimal amount of energy to effectively optimize the root zone temperature due to efficient heat insulation and direct proximity of the heater to the growing medium;

it provides convective air flow inside the plant growth container which increases aeration of the growing medium and benefits air pruning of the roots;

it generates heat with low electric power density on the large surface area of the plant growth container, which is mild and safe for the plants and prevents overheated localized spots;

it allows to measure the ambient temperature, control the root zone temperature and provide overheat protection of the electrical heating panel; thus controlling and optimizing the overall growth microclimate of the root zone;

it allows to stabilize the root zone temperature, avoiding possible fluctuation of the relative humidity and dew point temperature; thus preventing mold growth inside the growing medium of the plant growth container;

it allows to retrofit any standard plastic, metal, ceramic or fabric plant growth container, making the proposed invention a universal heating solution for horticulture;

it allows easy removal of the heating blanket from the container so that it can be easily replaced with a new plant growth container without the need of disconnecting all electrical connections of the temperature control means and electrical power source;

it allows to permanently embed the heating element panel into the plant growth container during its plastic molding process, making said heated container extremely durable, washable and reusable;

it provides static magnetic field with direct current travelling upwards or downwards of the plant growth container, while warming and optimizing the temperature of the growing medium and inducing better root growth;

it offers the use of antimicrobial medium in the electric heating blankets and insulation top covers; thus, suppressing the growth of mold and diseases inside the plant growth container;

it allows the safe use of DC and AC electric power to energize the heating blanket without emitting potentially harmful electromagnetic field to the plants and the growers;

it allows the use of electrical grounding directly connected to the growing medium for continuous electron exchange with the Earth, thus simulating the natural growing environment for the roots.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. An electrically heated plant growth container having durable construction for simultaneous warming and aerating roots of non-aquatic plants in a growing medium, said container comprising:
at least one flexible electric heating blanket, said blanket envelops an outside surface of said plant growing medium for warming an entire bulk of said growing medium;
at least one convective air flow medium for permeating an outside ambient air, drawn by convective force, inside said growing medium.

2. The electrically heated plant growth container according to claim 1, further comprising:
at least one temperature control means for controlling and stabilizing a root zone temperature inside said plant growing medium.

3. The electrically heated plant growth container according to claim 1, further comprising an insulation medium for retaining and reflecting heat generated by said heating blanket.

4. The electrically heated plant growth container according to claim 1, wherein said heating blanket is attached to an outside wall of said growth container.

5. The electrically heated plant growth container according to claim 1, wherein: said heating blanket is located between a wall and said growing medium of said growth container.

6. The electrically heated plant growth container according to claim 1, wherein said heating blanket is located at least at a bottom of said growth container.

7. The electrically heated plant growth container according to claim 1, wherein said heating blanket is embedded inside walls of said growth container.

8. The electrically heated plant growth container according to claim 1, wherein said growing medium is directly connected to an electrical grounding.

9. The electrically heated plant growth container according to claim 1, wherein said convective air flow medium comprises air permeable heating element holding means.

10. The electrically heated plant growth container according to claim 1, wherein said heating blanket comprises an air permeable insulation top cover.

11. The air permeable insulation top cover according to claim 10, further comprising antimicrobial medium.

12. The electrically heated plant growth container according to claim 1, wherein said heating blanket comprises antimicrobial medium.

13. The electrically heated plant growth container according to claim 1, wherein said heating blanket comprises a dual heating element cable to cancel an electromagnetic field when said heating blanket is electrically energized by an alternating current.

14. The electrically heated plant growth container according to claim 1, wherein said heating blanket is connected to a direct current electrical power source, said blanket comprises two parallel bus conductors, providing that one of said bus conductors is positioned closer to a bottom of said container and connected to a negative pole of said power source and a second of said bus conductors is positioned closer to a top of said container and electrically connected to a positive pole of said electrical power source.

15. An electrically heated plant growth container system having durable construction for warming non-aquatic plants in a growing medium, said system comprising:
at least one flexible electric heating blanket, said blanket envelops said plant growing medium for warming an entire bulk of said growing medium;
at least one temperature control means for controlling and stabilizing a root zone temperature of said plant growing medium;
at least one electrical power source for energizing said heating blanket.

16. The electrically heated plant growth container system according to claim 15, further comprising an insulation medium to retain and reflect heat generated by said heating blanket.

17. A method for simultaneous warming and aerating roots of non-aquatic plants inside a plant growth container, said method comprising:
enveloping a plant growing medium by a flexible electric heating blanket to warm an entire bulk of said growing medium;
energizing said plant growth container by an electrical power source;
drawing by a convective force an ambient air inside said growing medium through convective air flow medium.

18. The method for simultaneous warming and aerating roots of non-aquatic plants inside plant growth container as defined in claim 17, further including controlling of at least a root zone temperature inside said growing medium by temperature control means.

19. The method for simultaneous warming and aerating roots of non-aquatic plants inside plant growth containers as defined in claim 17, further comprising an electrical grounding, directly connected to said growing medium.

20. The method for simultaneous warming and aerating roots of non-aquatic plants inside plant growth containers as defined in claim 17, further comprising installing an insulation medium to retain and reflect heat generated by said heating blanket.

21. The method for simultaneous warming and aerating roots of non-aquatic plants inside plant growth container as defined in claim 17, further comprising installing an electrical connection in parallel of multiple heated plant growth containers, said multiple containers comprise one temperature control means having one temperature sensor inserted to the growing medium of one of said multiple containers, said temperature control means simultaneously controls an electrical power output in all of said multiple containers.
